(19) United States
(12) Patent Application Publication
(10) Pub. No.: US 2004/0121796 A1
(43) Pub. Date: Jun. 24, 2004

(54) Mobile device with auto-connecting function

(76) Inventor: Bao-Chi Peng, Taipei (TW)

Correspondence Address: Cynthia L. Pillote, Snell & Wilmer L.L.P., One Arizona Center, 400 East Van Buren, Phoenix, AZ, 85004-2202, US

(21) Appl. No.: 10/732,945

(22) Filed: Dec. 11, 2003

(30) Foreign Application Priority Data
Dec. 20, 2002 (TW) 91220796

(51) Int. Cl. H04B 7/00; H04Q 7/20; H04M 1/00; H04B 1/38

(52) U.S. Cl. 455/522; 455/550.1; 455/556.1; 455/569.1; 455/571; 455/572

(57) ABSTRACT

A mobile device including an auto-connecting module, a manual-connecting module and an earphone with a detecting device is provided. The detecting device generates a status signal in accordance with the status of the earphone. A processor in the mobile device has a determining module, which selectively executes the auto-connecting function or the manual-connecting function according to the status signal. The detecting device includes a switch and a control unit for controlling the switch. When the earphone is in operation, the control unit turns off the switch to make the auto-connecting module active.

### CROSS-REFERENCE TO RELATED APPLICATIONS

This Application claims priority to Taiwan Patent Application No. 091220796 entitled “Mobile Device with Auto-Answer Function,” filed Dec. 20, 2002.

### FIELD OF INVENTION

The present invention relates to an connecting function of a mobile device, and more particularly, to a mobile phone having a selectively auto-connecting function.

### BACKGROUND OF THE INVENTION

Mobile phones have become more and more popular nowadays, and even more, they have become one of the essential communication devices for modern people. Mobile phone users can answer mobile phones by using earphones without having to hold the mobile phone with their hands; earphones have become standard equipment for mobile phones. Mobile phones equipped with earphones generally have an auto-connecting function to avoid missing phone calls when earphones are being used. When a call comes in, the mobile phone can connect calling party automatically so that users wearing the earphone can answer the phone call directly.

However, users usually forget to switch the mobile phone from the auto-connecting mode to the manual-connecting mode after taking off their earphones. If a user is not wearing an earphone while the auto-connecting function is in operation, a phone call may be connected without the user answering it. This will lead to increasing missing calls and cause inconvenience for mobile phone users.

### SUMMARY OF THE INVENTION

The present invention provides a mobile device having a selectively auto-connecting function.

The mobile device includes an auto-connecting module for connecting calls automatically and a manual-connecting module for connecting calls manually. A connecting outlet of the mobile device is connected to the earphone via an earphone plug which has a first terminal, a second terminal and a third terminal. The first terminal receives a receiving speech signal, the second terminal transmits a transmitting speech signal, and the third terminal provides a first signal and receives a status signal. A processor with a determining module periodically detects the first signal ordering the mobile device to selectively execute the auto-connecting function and the manual-connecting function.

In the first embodiment of the present invention, the control unit of the detecting device includes a mechanical switch. When the earphone is not in use, the mechanical switch is turned on to make a voltage higher than a constant to choose the manual-connecting mode. When the earphone is put into operation, the mechanical switch is turned off to make the voltage lower than a constant to choose the auto-connecting mode. The earphone further includes a hook and a pad rotatably connecting with the hook. When the hook is clipped on an ear and rotates away from the pad, the mechanical switch will put the earphone in operation.

In the second embodiment of the present invention, the control unit predetermines that the mobile device is in a manual-connecting mode. In this embodiment, the control unit includes a pressure sensor. When the earphone is placed on an ear and the pressure sensor is pressed, the control unit will turn off the switch to change to the auto-connecting mode.

In the third embodiment of the present invention, the control unit predetermines that the mobile device is in a manual-connecting mode. In this embodiment, the control unit includes a first temperature sensor for observing a first temperature and a second temperature sensor for observing a second temperature. When the earphone is placed on an ear locating the first temperature sensor in an ear hole and observes the first temperature higher than the second temperature, the control unit transmits the operation-status signal to set the auto-connecting module active.

In the fourth embodiment of the present invention, the control unit predetermines that the mobile device is in a manual-connecting mode. In this embodiment, the control unit includes a touch switch and the earphone has a metallic housing. When the earphone is placed on an ear and the touching switch observes a corporeal noise through the metallic housing, the control unit transmits the operation-status signal to set the auto-connecting module active.

In the fifth embodiment of the present invention, the control unit predetermines that the mobile device is in a manual-connecting mode. In this embodiment, the control unit includes an ultrasonic transmitting device and an ultrasonic receiving device. When the earphone is placed on an ear and the ultrasonic receiving device receives an ultrasonic signal from the ultrasonic transmitting device, the control unit transmits the operation-status signal to set the auto-connecting module active.

In the sixth embodiment of the present invention, the control unit predetermines that the mobile device is in a manual-connecting mode. In this embodiment, the control unit includes an infrared ray transmitting device and an infrared ray receiving device. When the earphone is placed on an ear and prevents the infrared ray receiving device from receiving ultrasonic signals from the infrared ray transmitting device, the control unit transmits the operation-status signal to set the auto-connecting module active.

### BRIEF DESCRIPTION OF THE DRAWINGS

FIG. 1 shows a schematic diagram of the mobile device and the earphone of the present invention.

FIGS. 2A-2C show schematic diagrams of the earphone of the first embodiment of the present invention.

FIGS. 3A-3B show schematic diagrams of the earphone of the second embodiment of the present invention.

FIGS. 4A-4B show schematic diagrams of the earphone of the third embodiment of the present invention.

FIGS. 5A-5B show schematic diagrams of the earphone of the fourth embodiment of the present invention.

FIGS. 6A-6B show schematic diagrams of the earphone of the fifth embodiment of the present invention.

FIGS. 7A-7B show schematic diagrams of the earphone of the sixth embodiment of the present invention.

### DETAILED DESCRIPTION

The present invention provides a mobile device having a selectively auto-connecting function. According to the status of the earphone, the processor of the mobile device selectively executes the auto-connecting function or the manual-connecting function to avoid the condition that the auto-connecting function accepts calls when the user actually does not wear the earphone.

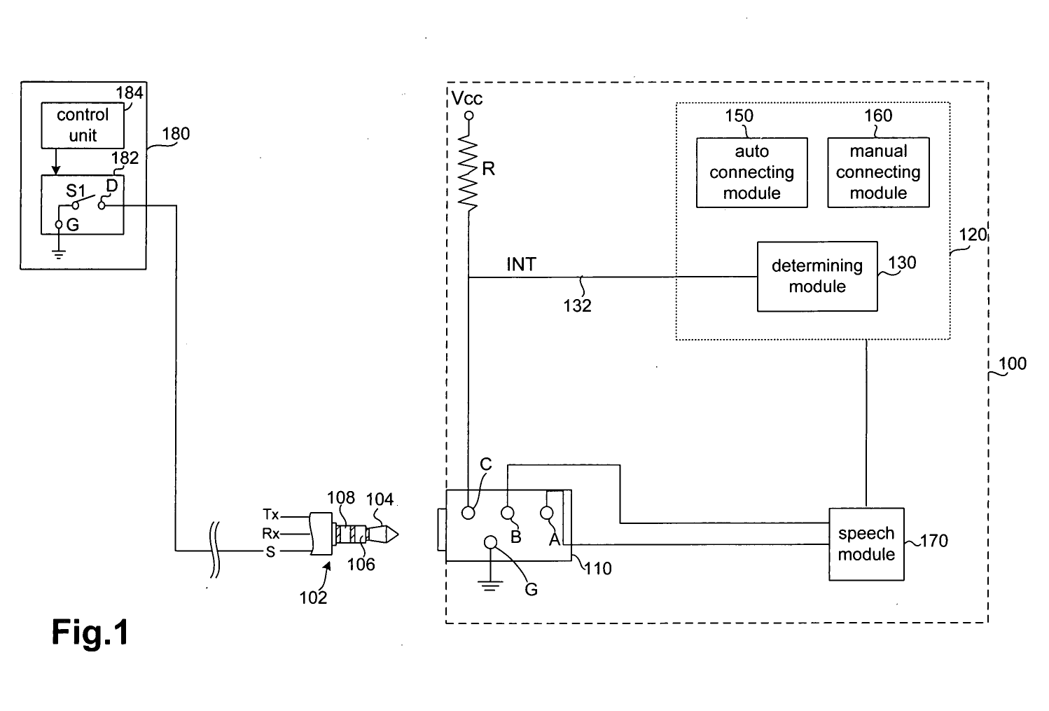

As shown in FIG. 1, the circuit 100 of the mobile device includes a outlet 110 connected to the earphone, the processor 120 and the speech module 170. The outlet 110 can be an earphone socket with three connecting terminals, A, B, and C, which are respectively connected to the first terminal 104, the second terminal 106 and the third terminal 108 of the earphone plug 102. The processor 120 includes the determining module 130 for controlling the auto-connecting module 150 to execute the auto-connecting function and the manual-connecting function 160 to execute the manual-connecting function. The speech device can be a speaker or a microphone here.

As shown in FIG. 1, the connecting end C of the earphone socket 110 is connected to a power source Vcc of the circuit 100 through a resistor R. The connecting end C provides a first signal TNT with a Boolean value “1” to the determining module 130 through the transmission line 132, when the earphone plug 102 is inserted into the earphone socket 110. The connecting end A of the earphone socket 110 is electrically connected to the first part 104 of the earphone plug 102 and transmits a second signal when the earphone plug 102 is inserted into the earphone socket 110. The connecting end B of the earphone socket 110 is electrically connected to the second part 106 of the plug 102 and transmits a third signal. The second signal and the third signal transmitted and received by the first part 104 and the second part 106 are transmitted to the earphone through Tx and Rx transmission lines of the earphone plug 102. Then the user can use the mobile device with the earphone.

As shown in FIG. 1, the third part 108 of the earphone plug 102 is electrically connected to the connecting end C of the earphone socket 110, and is connected to one end of the switch 182 in the earphone through the S transmission line behind the earphone plug 102. The switch 182 includes a switch SI, and another end of the switch 182 is connected to ground. When the switch S1 is turned on, it is in a close grounding circuit with the system power source Vcc and the resistor R, and the transmission line 132 provides a first signal INT with a Boolean value “0” to the determining module 130. When the switch S1 is turned off, the transmission line 132 provides a first signal INT with a Boolean value “1” to the determining module 130. As FIG. 1 shows, the detecting device 180 is an internal part of the earphone, and includes the switch 182 and the control unit 184, wherein the control unit 184 controls the switch 182.

The determining module 130 of the processor 120 controls the auto-connecting module 150 to execute auto-connecting function when the Boolean value equals “0” and the manual-connecting module 160 to execute manual-connecting function when the Boolean value equals “1” according to the first signal INT. When the mobile device in auto-connecting mode and a phone call comes in, the auto-connecting module 150 connects it automatically, and transmits the signals of the speech module 170 to the earphone socket 110 for the users to receive voices through the earphone. When the mobile device in manual-connecting mode as a phone call coming, the phone rings and if the user wants to get the call, the user presses a button on the mobile device to answer a phone call. What follows provide six embodiments of the present invention and methods of detecting the earphone status to interpret the present invention.

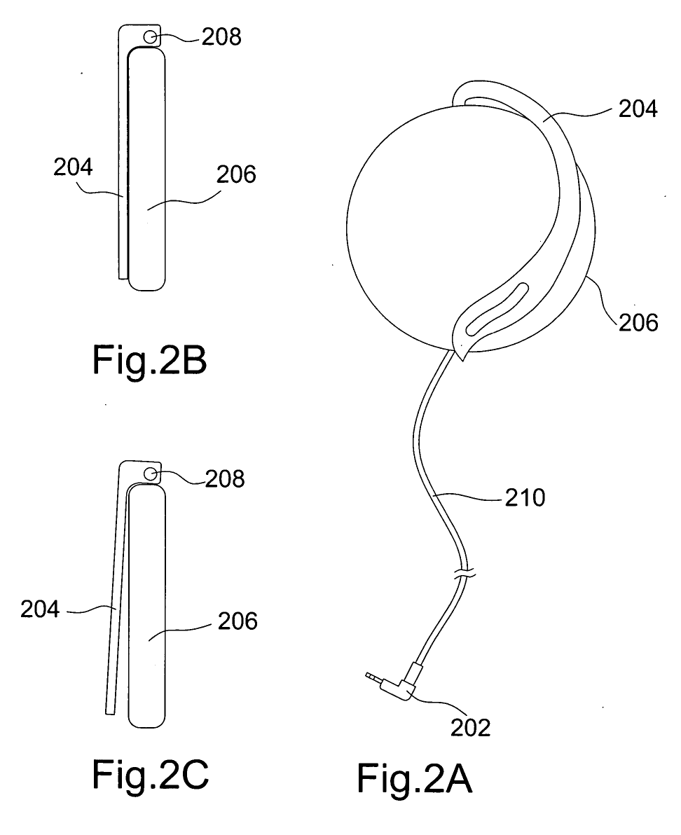

FIGS. 2A, 2B and 2C show schematic diagrams of the earphone of the first embodiment of the present invention. As shown in FIG. 2A, the earphone includes a pad 206 and a hook 204 for hanging the earphone on an ear and is connected to the earphone plug 202 through an earphone cord 210. The earphone cord 210 has a microphone (not illustrated) to transmit the user's voice. As shown in FIG. 2B, the hook 204 is not clipped on an ear and contacts the pad 206 and the axle 208 does not rotate when the earphone is not used. Here the control unit 184 of the detecting device 180 is a mechanical switch turning the switch S1 on or off When the earphone is not in use, the axle 208 does not rotate and the control unit 184 does not turn off the switch S1; thus the mobile device will accept phone calls manually.

As shown in FIG. 2C, when the earphone is clipped on an ear, the hook 204 relatively rotates away from the pad 206. The axle 208 rotates with the hook 204, and the mechanical switch, the control unit 184, turns off the switch S1. Therefore, the mobile device chooses the auto-connecting mode when the earphone is clipped on an ear, and chooses the manual-connecting mode when the user takes off the earphone. Therefore, using the present invention may prevent missing phone calls when the user takes off the earphone without remembering to switch the answering mode.

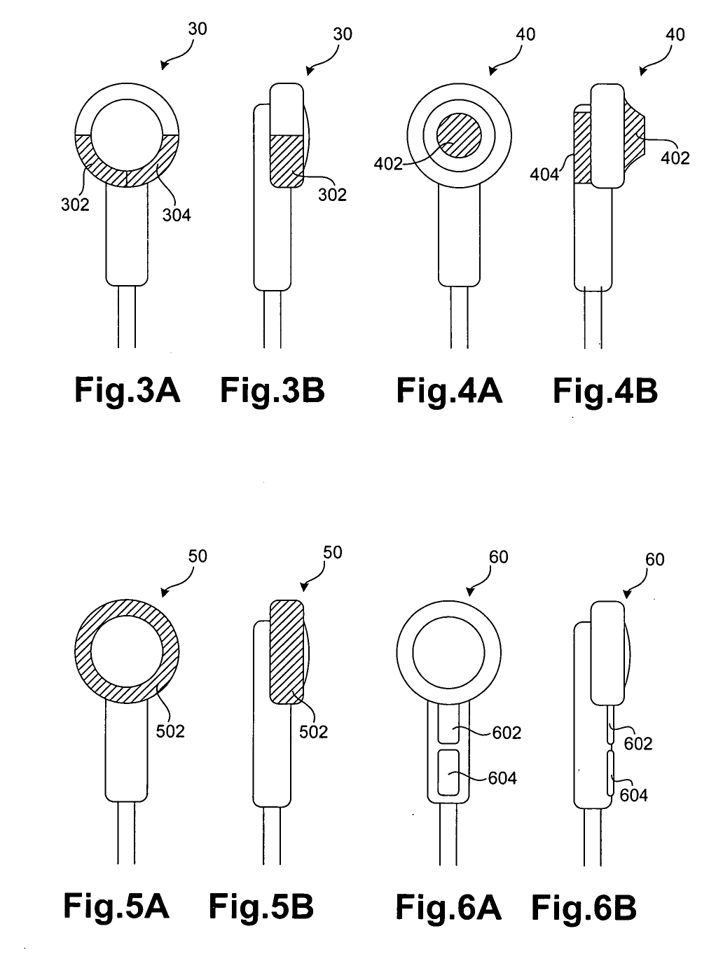

FIG. 3A and FIG. 3B show schematic diagrams of the earphone of the second embodiment of the present invention. In this embodiment, the manual-connecting mode is the default setting as the switch S1 of FIG. 1 is on. As FIG. 3A shows, the control unit 184 of the earphone 30 includes pressure sensors 302 and 304. The number and the location of the pressure sensors are decided according to the shape of the earphone and the position the user wears it. This embodiment uses two pressure sensors, sensors 302 and 304, to avoid false status signals produced when the only pressure sensor is pressed in a one-pressure-sensor configuration.

FIG. 3B is a side view of the earphone 30. When the earphone is placed on an ear to press the pressure sensors 302 and 304, the control unit 184 turns off the switch S1 to execute the auto-connecting function. Therefore the auto-connecting function is executed only when the earphone is placed on an ear. For the rest of the time, the manual-connecting function is executed to prevent missing phone calls.

FIG. 4A and FIG. 4B show schematic diagrams of the earphone of the third embodiment of the present invention. In this embodiment, the manual-connecting mode is the default setting as the switch S1 of FIG. 1 is on. The control unit 184 includes the first temperature sensor 402 and the second temperature sensor 404. The first temperature sensor 402 observes a first temperature as the second temperature sensor 404 observes a second temperature. When the earphone 40 is placed on an ear, the first temperature sensor 402 is placed in an ear hole. The number and the location of the second temperature sensor 404 are decided according to the earphone design, and are not restricted by FIG. 4A and FIG. 4B. Here the control unit 184 includes temperature sensors 402 and 404. When the earphone 40 is placed on an ear and the control unit 184 observes the first temperature higher than the second temperature, the control unit 184 turns off the switch S1 to set the auto-connecting module active. Therefore the auto-connecting function is executed only when the earphone is placed on an ear. For the rest of the time, the manual-connecting function is executed to prevent missing phone calls.

FIG. 5A and FIG. 5B show schematic diagrams of the earphone of the fourth embodiment of the present invention. In this embodiment, the manual-connecting mode is the default setting as the switch S1 of FIG. 1 is on. The control unit 184 of the earphone 50 includes a touch switch connected to the housing 502. The housing 502 of the earphone is preferably made by metal or other materials that can transmit corporeal noises. When the earphone 50 is placed on an ear and the touch switch observes a corporeal noise from the metallic housing 502, the control unit 184 turns off the switch S1 to choose the auto-connecting mode. Therefore the auto-connecting function is executed only when the earphone 50 is placed on an ear. For the rest of the time, the manual-connecting function is executed to prevent missing a phone call.

FIG. 6A and FIG. 6B show schematic diagrams of the earphone of the fifth embodiment of the present invention. In this embodiment, the manual-connecting mode is the default setting as the switch S1 of FIG. 1 is on. The control unit 184 includes an ultrasonic transmitting device 604 and an ultrasonic receiving device 602. The numbers and the locations of the ultrasonic transmitting device 604 and the ultrasonic receiving device 602 are decided according to the earphone design, and are not restricted by FIG. 6A and FIG. 6B. When the earphone 60 is placed on an ear and the ultrasonic receiving device 602 receives ultrasonic signals from the ultrasonic transmitting device 604, the control unit 184 turns off the switch S1 to choose the auto-connecting mode. Therefore the auto-connecting function is executed only when the earphone 60 is placed on an ear. For the rest of the time, the manual-connecting function is executed to prevent missing phone calls.

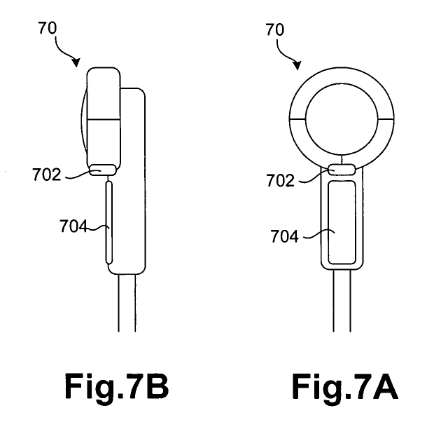

FIG. 7A and FIG. 7B show schematic diagrams of the earphone of the sixth embodiment of the present invention. In this embodiment, the manual-connecting mode is the default setting as the switch S1 of FIG. 1 is on. The control unit 184 includes an infrared ray transmitting device 704 and an infrared ray receiving device 702. The numbers and the locations of the infrared ray transmitting device 704 and the infrared ray receiving device 702 are decided according to the earphone design, and are not restricted by FIG. 7A and FIG. 7B. When the earphone 70 is placed on an ear and the infrared ray receiving device 702 cannot receive the infrared ray signal from the infrared ray transmitting device 704, the control unit 184 turns off the switch S1 to set the auto-connecting module active. Therefore the auto-connecting function is executed only when the earphone 60 is placed on an ear. For the rest of the time, the manual-connecting function is executed to prevent missing phone calls.

While the invention has been described in connection with what is presently considered to be the most practical and preferred embodiments, it is to be understood that the invention is not to be limited to the illustrative embodiments set forth herein. The invention is intended to cover various modifications and equivalent arrangements included within the spirit and scope of the appended claims.

I claim:

1. A mobile device with a selective connecting function, the mobile device comprising:
an earphone including a detecting device for providing a status signal of a using status of the earphone; and
a processor, including:
an auto-connecting module for executing an auto-connecting function;
a manual-connecting module for executing a manual-connecting function; and
a determining module, responsive to the status signal, for controlling the mobile device to selectively execute the auto-connecting function and the manual-connecting function.

2. The mobile device of claim 1, the mobile device further comprising:
a connecting device for connecting to the earphone, the connecting device having a first terminal;
a transmission line, one terminal of the transmission line electrically connecting to the processor for transmitting the status signal;
a voltage source; and
a resistor, one terminal of the resistor connecting to the voltage source, another terminal of the resistor connecting to the first terminal of the connecting device and another terminal of the transmission line;
wherein the detecting device connects to the connecting device, and controls the status signal selectively being in a low level and a high level.

3. The mobile device of claim 2, wherein the detecting device includes:
a switch, one terminal of the switch connecting to ground, another terminal of the switch connecting to the first terminal of the connecting device, and
a control unit for controlling the switch.

4. The mobile device of claim 3, wherein the control unit includes a mechanical switch, and when the earphone is in a depressed state, the mechanical switch turns off the switch.

5. The mobile device of claim 3, wherein the control unit turns on the switch when the earphone is in an operation state.

6. The mobile device of claim 3, wherein the earphone further includes a hook and a pad rotatably connecting with the hook, when the hook clips an ear and rotates relatively to the pad, the control unit switch makes the earphone in the operation state.

7. The mobile device of claim 3, wherein the control unit includes a pressure sensor, when the earphone is placed on an ear to press the pressure sensor, the control unit turns on the switch.

8. The mobile device of claim 3, wherein the control unit includes a first temperature sensor for measuring a first temperature and a second temperature sensor for measuring a second temperature, the control unit turns on the switch when the first temperature is higher than the second temperature.

9. The mobile device of claim 3, wherein the control unit includes an ultrasonic transmitting device and an ultrasonic receiving device, when the ultrasonic receiving device receives an ultrasonic signal, the control unit turns on the switch.

10. The mobile device of claim 3, wherein the control unit includes an infrared ray transmitting device and an infrared ray receiving device, when the infrared ray receiving device receives no infrared ray signal, the control unit turns on the switch.

11. The mobile device of claim 2, wherein the connecting device includes an earphone socket.

12. A mobile phone with a selective connecting functions, the mobile phone comprising:
an earphone including a detecting device for providing a status signal according to a status of the earphone;
an earphone socket for connecting to the earphone, the earphone socket having a first terminal;
a transmission line, for transmitting the status signal;
a voltage source;
a resistor, one terminal of the resistor connecting to the voltage source, another terminal of the resistor connecting to the first terminal of the earphone socket and one terminal of the transmission line; and
a processor electrically connecting to another terminal of the transmission line and receiving the status signal from the transmission line, the processor including:
an auto-connecting module for executing an auto connecting function;
a manual-connecting module, for executing a manual-connecting function; and
a determining module, responsive to the status signal, for controlling the mobile device to selectively execute the auto-connecting function and the manual-connecting function.

13. The mobile phone of claim 12, wherein the detecting device includes:
a switch; one terminal of the switch connecting to ground, another terminal of the switch electrically connecting to the first terminal of the earphone socket; and
a control unit for controlling the switch.

14. The mobile phone of claim 13, wherein the control unit includes a mechanical switch, and when the earphone is in a depressed state, the mechanical switch turns off the switch.

15. The mobile phone of claim 13, wherein the control unit turns on the switch when the earphone is in an operation state.

16. The mobile phone of claim 13, wherein the earphone further includes a hook and a pad rotatably connecting with the hook, when the hook clips an ear and rotates relatively to the pad, the control unit makes the earphone in the operation state.

17. The mobile phone of claim 13, wherein the control unit includes a pressure sensor, when the earphone is placed on an ear to press the pressure sensor, the control unit turns on the switch.

18. The mobile phone of claim 13, wherein the control unit includes a first temperature sensor for measuring a first temperature and a second temperature sensor for measuring a second temperature, the control unit turns on the switch when the first temperature is higher than the second temperature.
